(19) United States
(12) Patent Application Publication
(10) Pub. No.: US 2011/0202648 A1
(43) Pub. Date: Aug. 18, 2011

(54) NETWORK NODE FOR AN AD-HOC NETWORK AND PROCESS FOR PROVIDING APPLICATION SERVICES IN AN AD-HOC NETWORK

(75) Inventors: Oliver Nagy, Wien (AT); Refi-Tugrul Güner, Baden (AT); Erwin Toplak, Trumau (AT)

(73) Assignee: KAPSCH TRAFFICCOM AG, Wien (AT)

(21) Appl. No.: 13/027,084

(22) Filed: Feb. 14, 2011

(30) Foreign Application Priority Data
Feb. 18, 2010 (EP) 10450023.6

(51) Int. Cl. G06F 15/173

(52) U.S. Cl. 709/223

(57) ABSTRACT

A network node for an ad-hoc network having a plurality of network nodes of the same type, which provide one another with application services via wireless connections. The network node generates a list of all application services provided to it by other network nodes including associated quality classes and makes this list available to other network nodes as list of the application services provided by it with such quality classes. The quality class is at least dependent on the number of consecutive network nodes, via which the application service is provided, and the quality class specified by the last of these network nodes. The invention also relates to a method for providing application services in an ad-hoc network.

### CROSS-REFERENCE TO RELATED APPLICATION(S)

This application claims priority to European Patent Application No. 10 450 023.6, filed on Feb. 18, 2010, the contents of which are hereby expressly incorporated by reference.

### FIELD OF THE INVENTION

The present invention relates to a network node for an ad-hoc network having a plurality of network nodes of the same type, which provide one another with application services via wireless connections. The invention also relates to a process for providing application services in an ad-hoc network, the network nodes of which provide one another with application services via wireless connections.

### BACKGROUND

Wireless ad-hoc networks, i.e. networks that are formed from a group of peers (network nodes) spontaneously connecting to one another and are generally highly dynamic because of the movement and changeover of network nodes.

Many routing algorithms have already been proposed for vehicular ad-hoc networks (VANETs) to find the best possible route for data packets from one network node to another network node. However, the known routing algorithms for VANET network graph models are not suitable for the provision of satisfactory network-wide application service switching.

### SUMMARY

The present invention relates in particular to the application of ad-hoc network technologies for networking vehicles in so-called vehicular ad-hoc networks (VANETs).

In some embodiments, the present invention is a network node for an ad-hoc network having a plurality of network nodes of the same type, the plurality of network nodes providing one another with application services via wireless connections. The network node is configured to generate a list of all application services provided thereto by other network nodes, the list including associated quality classes, and make said list available to other network nodes with said quality classes. The quality class is at least dependent on a number of consecutive network nodes via which the application service is provided, and the quality class specified by the last of the network nodes.

In some embodiments, the present invention is a method for providing application services in an ad-hoc network having a plurality of network nodes providing one another with application services via a wireless connection. The method includes: in a network node, creating a list of all application services provided thereto by other network nodes including associated quality classes; and making said list available to other network nodes as a list of application services including said quality classes. The quality class is at least dependent on the number of consecutive network nodes via which the application service is provided, and the quality class specified by the last of the network nodes.

### BRIEF DESCRIPTION OF THE DRAWINGS

FIG. 1 shows an overview of a vehicular ad-hoc network with network nodes according to the invention;

FIG. 2 shows a detail in sectional view of the network of FIG. 1;

FIG. 3 shows an exemplary structure of a LAST list in a network node, according to some embodiments of the present invention; and

FIG. 4 is an exemplary schematic diagram of quality classes and their variation from network node to network node, according to some embodiments of the present invention.

### DETAILED DESCRIPTION

In some embodiments, the present invention provides a network node of a VANET that is distinguished in that it generates a list of all application services provided to it by other network nodes with associated quality classes. The invention then makes this list available to other network nodes as list of the application services provided by it with such classes. The quality class is at least dependent on the number of consecutive network nodes, via which the application service is provided, and the quality class specified by the last of these network nodes.

In this way, in each network node a local application overview is generated in the form of the list of all application services available to this network node with their respective service quality. The list is also referred to as “local available service table” (LAST). The LAST list of a network node is composed—recursively as it were—of the LAST lists of the adjacent nodes receivable by this network node, which are in turn composed of the LAST lists of their adjacent network nodes, and so on. The LAST lists can therefore be generated locally and independently by each network node and still provide a complete overview of all application services currently available in the entire ad-hoc network without requiring a central distribution or survey mechanism or any specific routing algorithms.

The quality class is preferably additionally dependent on the connection quality of the last wireless connection, via which the application service is provided, wherein it is in turn particularly preferred if the connection quality is dependent on the bandwidth, the latency and/or movement vectors of the wireless connection. As a result, highly dynamic and highly mobile network topographies can also be taken into consideration.

According to some embodiments of the invention, the network node additionally contains a list of booked application services and matches the LAST list with said booked application services and in the case of a match notifies an application in the network node. As a result, entry into specific service coverage regions can be detected and associated applications can be automatically launched, for example.

The list of provided application services may also include an access authorisation class for each application service, for example, depending on associated cost or user group.

The network node according to the invention is particularly suitable for vehicular ad-hoc networks (VANETs), in which case it is an onboard unit (OBU), such as currently used, for example, for wireless toll systems, according to the DSRC, WAVE or GPS/GSM standard.

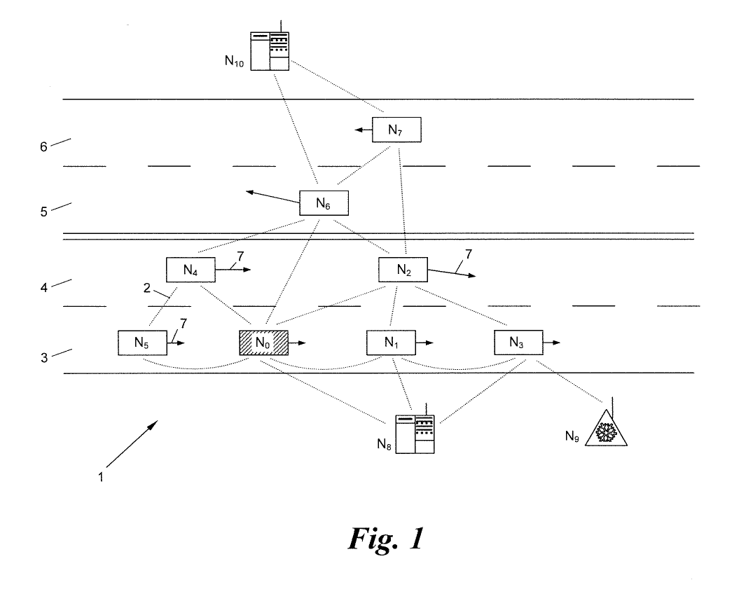

FIG. 1 shows a snapshot of an exemplary ad-hoc network 1 comprising a plurality (here eleven) of network nodes N₀, N₁, . . . N₁₀, which can communicate with one another via wireless connections 2. The wireless connections 2 generally have a limited range, and therefore one network node Nᵢ only communicates with closely adjacent network nodes, i.e. via a single wireless connection 2 (“single hop”), whereas it communicates indirectly with other network nodes, i.e. via multiple consecutive wireless connections 2 or intermediate network nodes Nᵢ (“multi-hop”).

The wireless connections 2 can be of any type known in the art, for example, DSRC, mobile radio or WLAN connections, in particular according to the WAVE standard (wireless access in a vehicle environment).

In the shown example, some of the network nodes Nᵢ are onboard units (OBUs) that are carried by vehicles (see network nodes N₀-N₇), others are, for example, stationary network nodes such as an exemplary wireless toll station N₈ (toll beacon), an ice warning system N₉ or a wireless interne access point N₁₀. Any other desired types of network nodes Nᵢ are conceivable, for example, wireless vending machines for entry tickets, parking tickets, city toll tickets or the like, communication terminals, traffic monitoring systems, mobile access points etc.

The in-vehicle network nodes N₀-N₇ in the shown example are moving on a four-lane motorway with two lanes 3, 4 running in one direction of travel and two lanes 5, 6 running in the other direction of travel. The arrows 7 indicate the current speed vector (speed, direction) of the mobile OBU network nodes N₀-N₇.

The network nodes N; provide one another with application services Sₙ via the wireless connections 2, i.e. both those directly originating in the respective provider network node, see, for example, the ice warning services S₁ of network node N₉, and those that are merely passed on from a network node, as is primarily the case with OBU network nodes N₀-N₇. In the same way, the application services Sₙ, provided to a network node Nᵢ can be used by this network node itself, for example, by a software application running on the network node Nᵢ and can also be passed from this network node onto other network nodes again.

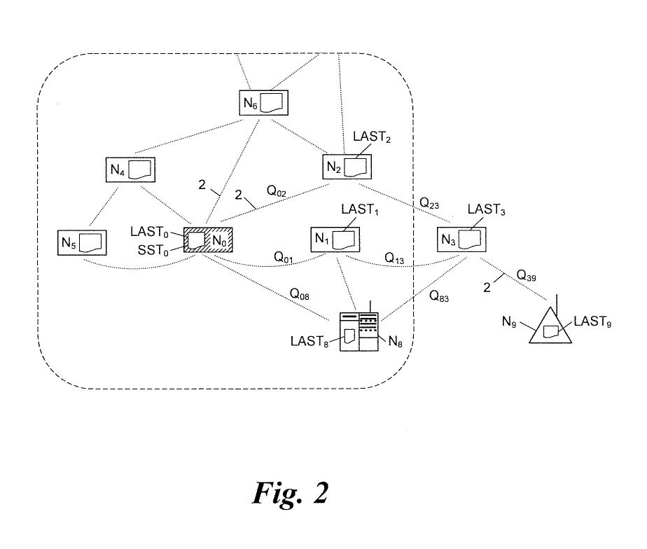

Each network node N; generates a list LASTᵢ of all application services Sₙ provided to it by other receivable network nodes Nᵢ (via wireless connections 2). The list LASTᵢ is now explained in more detail with reference to FIGS. 2-4.

FIG. 2 shows a simplified sectional view onto the ad-hoc network of FIG. 1, viewed from the network node N₀, which generates its LAST list, LAST₀ on the basis of the direct wireless connections 2 with its directly adjacent network nodes N₁, N₂, N₄, N₅, N₆ and N₈. The latter nodes themselves have respective lists LASTᵢ—generated from their local overview. In general teens, the lists LASTᵢ are respectively generated “recursively” as it were from the lists of the receivable network nodes Nᵢ.

For each application service Sₙ available for the network node Nᵢ, each list LASTᵢ contains a quality class QECᵢₙ, (quality estimate class) of the application service Sₙ. The quality class QECᵢₙ is composed of a number of consecutive wireless connections 2 or network nodes Nᵢ, via which the application service Sₙ is provided (“hops”), and the quality class QECⱼₙ specified by the last network node Nⱼ in its list LASTⱼ. The quality class QECⱼₙ may also be composed of the connection quality Qᵢⱼ, of the last wireless connection 2, via which the application service Sₙ is provided to the network node Nᵢ by the last network node Nⱼ.

As an example, consider an “ice warning” service, which is provided by the network node N₉ in its list LAST₉ as service S₁. For example, the best quality class QEC₉₁ of “0” (representative of “zero hop”, high availability and high bandwidth) is classified in the list LAST₃ of the next network node N₃ (after transmission via the wireless connection 2 with the connection quality Q₃₉) in the lower quality class QEC₃₁ of “1”. The best quality class QEC₉₁ may stand for “single hop”, high availability and a slightly reduced bandwidth, as a result of, for example, a connection quality Q₃ₗ of the wireless connection 2 of 90%.

The next network node N₁ on the propagation route towards the network node Nₒ in turn builds its list LAST₁ on the LAST lists of the network nodes in the vicinity, including the LAST₃ list of the network node N₃. The node N₁ once again calculates a quality class QEC₁₁ for the ice warning service S₁ with the consideration that there are now already two hops present, and with consideration of the connection quality Q₁₃ from network node N₃ to network node N₁. Similarly, the network node N₀ in turn generates its LAST₀ list from the data of the LAST₁ list, amongst other things, by incrementing the number of hops by 1, with consideration of the connection quality Q₀₁ and new classification of the service quality of the ice warning service S₁ in the quality class QEC₀₁ of, for example, “3”, representative of “triple hop”, high availability and a bandwidth of, for example, 60%.

If in one network node Nᵢ (for example, network node N₀) the same service (for example, the ice warning service S₁ of network node N₉) can be switched via different paths in the ad-hoc network 1 (for example, here via N₉-N₃-N₂-N₀, N₉-N₃-N₁-N₀, N₉-N₃-N₈-N₀ etc.) then, these different possibilities can be included as different service entries Sₙ in the list LASTᵢ, respectively with the corresponding quality class QECᵢₙ, or only the entry with the best quality class QECᵢₙ can be respectively stored in the list, which leads to an implicit best routing.

The connection quality Qᵢⱼ of a wire connection 2 can be dependent on a plurality of parameters, which a network node can preferably determine itself. The parameters may include the bandwidth and/or the latency of the wireless connection 2 and/or the latency of the application service Sₙ, if this is a processing service, for example. The connection quality Qᵢⱼ can preferably also take the movement vectors 7 of the partners of the respective wireless connection 2 into consideration. For example, network nodes that are expected to only encounter one another briefly on the basis of their vectors 7, result in a lower quality class for application services provided than other less dynamic wireless connections 2, for example, between two network nodes moving approximately equally quickly in the same direction. See, for example, the network node N₆ approaching network node N₄ or the network node N₄ overtaking network node N₅ in FIG. 1

The following Table 1 shows some examples of quality classes QEC, which can be defined on the basis of the number, bandwidth, latency and/or direction vectors of the wireless connections or participating network nodes and/or the availability class of the service provider:

TABLE 1

| | |
|---|---|
| QEC = 1 | Single hop, probable availability 100% |
| QEC = 2 | Single hop, probable availability 90% |
| | (e.g. 100 kbit/s for 30 seconds) |
| QEC = 3 | Triple hop, probable availability 80% |
| QEC = 4 | Double hop, probable availability 60% |

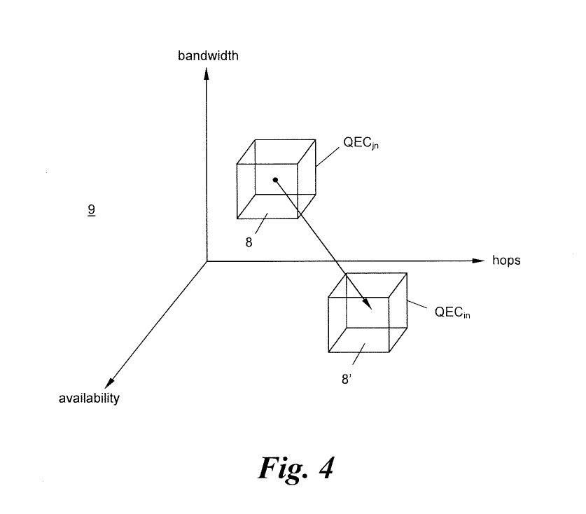

As shown in FIG. 4, the quality class QECᵢₙ or QECⱼₙ of an application service Sₙ in the list LASTᵢ of a network node Nᵢ or Nⱼ can also be seen as a restricted region 8 or 8′ in a multidimensional space 9, which the individual parameters such as hops, bandwidth, availability etc. cover. Variations in one or more of these parameters can lead to classification in the list LASTᵢ of the next network node Nᵢ in a different region 8′ from previously (8) and thus in a different quality class QECᵢₙ from previously (QECⱼₙ). For example, the variation may occur when an application service Sₙ is passed on from one network node Nⱼ to another network node Nᵢ,

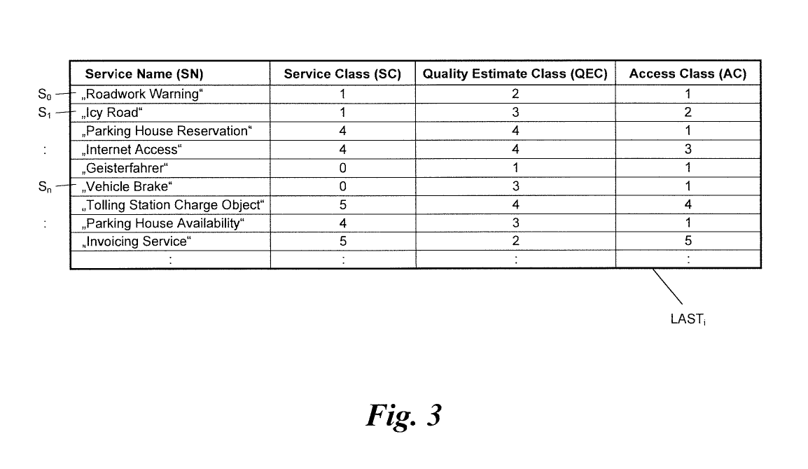

In addition to the quality class QEC, the list LASTᵢ can also contain a service class SC for each application service Sₙ, as shown in FIG. 3 and the following Table 2:

TABLE 2

| | |
|---|---|
| SID = 0 | Safety alert service vehicle |
| SID = 1 | Safety alert service infrastructure |
| SID = 2 | Sensor service vehicle |
| SID = 3 | Sensor service infrastructure |
| SID = 4 | Service point |
| SID = 5 | Infrastructure charging point service |
| SID = 6 | Infrastructure tolling info point service |

The service class SC can be used, for example, by network node Nᵢ or its applications in order to “book” application services Sₙ, of a specific service class SC. A software application on a network node Nᵢ can thus be notified automatically, for example, if an application service Sₙ of a specific service class SC is available. Specific application services Sₙ can, of course, also be booked directly in a network node Nᵢ the basis of their name (service name, SN).

The list LASTᵢ can also contain an access authorisation class AC for each application service Sₙ, as shown in FIG. 3 and the following Table 3:

TABLE 3

| | |
|---|---|
| AC = 1 | Free access for all |
| AC = 2 | Safety subscriber, certificate required, flat fee |
| AC = 3 | Convenience subscriber, certificate required |
| AC = 4 | Tolling service provider, certificate required |
| AC = 5 | Roadside warning service provider, no certificate |

The access class AC can be applied by network nodes Nᵢ, or their software applications to match the access authorisation to a specific application service.

A network-wide certificate system can be implemented for utilisation of the application services Sₙ, made available to a network node Nᵢ. For this purpose, the network nodes Nᵢ or the applications running on them, can identify themselves to the application services Sₙ utilised by means of appropriate public/private key certificates, as is known in the art. It is also possible in this case to use time-restricted certificates so that application service requests, which are transmitted to application service providers from network nodes with time-restricted certificates, can be authenticated and implemented in a time-controlled and/or time-checked manner.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A network node for an ad-hoc network having a plurality of network nodes of the same type, the plurality of network nodes providing one another with application services via wireless connections, wherein the network node is configured to
generate a list of all application services provided thereto by other network nodes, the list including associated quality classes, and
make said list available to other network nodes with said quality classes, and wherein
said quality class is at least dependent on a number of consecutive network nodes via which the application service is provided, and the quality class specified by a last of said network nodes.

2. The network node according to claim 1, wherein the quality class is additionally dependent on a connection quality of a last wireless connection via which the application service is provided.

3. The network node according to claim 2, wherein the connection quality is dependent on one or more of a bandwidth and a latency of the last wireless connection.

4. The network node according to claim 2, wherein the connection quality is dependent on movement vectors of the last wireless connection.

5. The network node according to claim 1, further comprising a list of booked application services, wherein the network node is further configured to match the list of application services with said list of booked application services, and in the case of a match, to notify an application in the network node.

6. The network node according to claim 1, wherein the list of application services also contains an access authorisation class for each application service.

7. The network node according to claim 1, wherein said network node is included in an onboard unit.

8. A method for providing application services in an ad-hoc network having a plurality of network nodes providing one another with application services via a wireless connection, the method comprising:
in a network node, creating a list of all application services provided thereto by other network nodes including associated quality classes; and
making said list available to other network nodes as a list of application services including said quality classes,
wherein said quality class is at least dependent on the number of consecutive network nodes via which the application service is provided, and the quality class specified by a last of said network nodes.

9. The method according to claim 8, wherein the quality class is additionally dependent on a connection quality of a last wireless connection via which the application service is provided.

10. The method according to claim 9, wherein the connection quality is dependent on one or more of a bandwidth, a latency, and movement vectors of the last wireless connection.

11. The method according to claim 8, further comprising providing a list of booked application services; matching the list of application services with said list of booked application services; and in the case of a match, notifying an application in the network node.

12. The method according to claim 8, wherein the list of application services also contains an access authorisation class for each application service.
